(19) United States
(12) Patent Application Publication
(10) Pub. No.: US 2019/0097210 A1
(43) Pub. Date: Mar. 28, 2019

(54) EXTRAORDINARY CAPACITY OF TITANIUM DIOXIDE (TIO2) NANOSTRUCTURES TOWARDS HIGH POWER AND HIGH ENERGY LITHIUM-ION BATTERIES

(71) Applicant: Nanyang Technological University, Singapore (SG)

(72) Inventors: Xiaodong CHEN, Singapore (SG); Yuxin TANG, Singapore (SG)

(21) Appl. No.: 16/078,755

(22) PCT Filed: Feb. 23, 2017
(86) PCT No.: PCT/SG2017/050082

§ 371 Date: Aug. 22, 2018

(30) Foreign Application Priority Data
Feb. 23, 2016 (SG) 10201601358R

(51) Int. Cl. H01M 4/131; H01M 4/04; H01M 4/1391; H01M 4/485; H01M 4/62; H01M 10/0525

(52) U.S. Cl. CPC H01M 4/131; H01M 4/0471; H01M 4/1391; H01M 2004/021; H01M 4/625; H01M 10/0525; H01M 4/485

(57) ABSTRACT

A titanium dioxide (TiO₂) nanostructure for use as an electrode component in a lithium-ion battery is provided. The electrode component is formed by charging and discharging the TiO₂ nanostructure in an electrochemical cell from a high voltage of 1.0 to 3.0 V to a low voltage of 0.01 to 3.0 V at a charging rate of 2 to 100 C, wherein 1 C represents 175 mA/g. A lithium-ion electrochemical cell comprising the electrode is also provided. A lithium-ion battery comprising a plurality of the lithium-ion electrochemical cells is further provided.

### CROSS-REFERENCE TO RELATED APPLICATION

This application claims the benefit of priority of Singapore Patent Application No. 10201601358R, filed Feb. 23, 2016, the contents of which being hereby incorporated by reference in its entirety for all purposes.

### TECHNICAL FIELD

The invention relates generally to lithium-ion batteries, and in particular, to electrodes of the lithium-ion batteries, wherein the electrodes are formed of extraordinary capacity titanium dioxide nanostructures.

### BACKGROUND

Development of high-performance lithium-ion batteries (LIBs) with ultrafast charging and discharging rates is highly important for portable electronic devices and electrical vehicles. However, the current commercialized graphite anode is still suffering from potential safety issues (thermal runaway), with the formation of lithium dendrites and solid-electrolyte interphase (SEI) layer, due to its low lithiation potential (0.2 V vs. Li/Li⁺), especially when the LIBs are operated at high current rates. Therefore, the search for a suitable electrode material addressing the above challenges is desired.

Possessing elevated operating potential (above 0.8 V vs. Li/Li⁺), titanium dioxide (TiO₂) materials are capable of avoiding lithium plating and prohibiting decomposition of the electrolyte, rendering them as promising safe anode material candidates for LIBs. Moreover, TiO₂ materials show negligible structural strain and small volume change (<4%) upon lithiation/delithiation processes, making them highly stable with long cycle life. To date, three TiO₂ polymorphs including rutile, anatase, and TiO₂-B (bronze) have been reported as anode materials. Rutile (tetragonal, P4₂/mnm) is the most thermodynamically stable phase, however, studies have shown that in bulk form, only small fractions of lithiation sites in rutile can be accessed because half of the interstitial octahedral sites are occupied to form coordinated TiO₆ octahedral, resulting in low theoretical capacity of 33.5 mAh/g (Li_{0.1}TiO₂). Compared to rutile, anatase polymorph (tetragonal, I4₁/amd) offers much higher specific capacity of 167 mAh/g even in bulk form, corresponding to Li_{0.5}TiO₂ Nanostructuring the material could further enhance the surface storage behavior and improve the overall capacity to 285 mAh/g. However, during the charge/discharge processes, Li⁺ ions insert into/extract from the anatase phase through solid-state diffusion, potentially deteriorating its high rate performance. Among these commonly used polymorphs, TiO₂-B (monoclinic, C2/m) has the highest theoretical capacity up to 335 mAh/g. Compared to rutile and anatase TiO₂, TiO₂-B contains open channel structure, which is beneficial to pseudocapacitive Li⁺ ions storage. Such open channel enables improved diffusion kinetics of Li⁺ ions and favoring Li-ion insertion even in bulk form. Although the TiO₂-based materials possess the high-rate capability, the capacity of the TiO₂ is limited to the 335 mAh/g, which is due to the limited sites for lithium ion uptake. According to the literature (Reddy M. V. et al. Chem. Rev. 2013, 113, 5364-5457), the highest capacity for the TiO₂ materials is around 598 mAh/g for the first cycles, and the capacity drops dramatically to 335 mAh/g after 60 cycles.

Therefore, there remains a need to provide for an improved TiO₂ material for use as an electrode component in a lithium-ion battery that overcomes, or at least alleviates, the above drawbacks.

### SUMMARY

According to one aspect of the disclosure, a titanium dioxide (TiO₂) nanostructure for use as an electrode component in a lithium-ion battery is described. The electrode component may be formed by charging and discharging the TiO₂ nanostructure in an electrochemical cell from a high voltage of 1.0 to 3.0 V to a low voltage of 0.01 to 3.0 V at a charging rate of 2 to 100 C, wherein 1 C represents 175 mA/g.

According to another aspect of the disclosure, a lithium-ion electrochemical cell, comprising a first electrode and a second electrode separated by an electrolyte is disclosed. One of the first and second electrodes may include the TiO₂ nanostructure of the earlier described aspect.

According to a further aspect of the disclosure, a lithium-ion battery is provided. The lithium-ion battery may include a plurality of electrochemically linked lithium-ion electrochemical cells of the earlier described aspect.

According to yet another aspect of the disclosure, a method for forming the TiO₂ nanostructure of the earlier described aspect is disclosed. The method may include mixing a TiO₂ nanostructure with a trace amount of conductive carbonaceous particles and calcining the mixture to obtain the TiO₂ nanostructure having a plurality of conductive carbonaceous particles attached thereto, wherein the weight composition of the conductive carbonaceous particles based on the total weight of the resultant TiO₂ nanostructure is 10.0 wt % or less.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows FESEM images of the (a) TNT and (b) PS-TNT, (c) TGA analysis for the PS-TNT and TNT sample after annealing at 750° C., 2 h, (d) the temperature-depended activation for the pure TNT without the PS particles, and (e) the electrochemical performance of pure TNT (without addition of polystyrene) cycled at different voltage windows. It is noted in (e) that the performance at 0.01 V to 3.0 V, 0.2 V to 3.0 V, 0.5 V to 3.0 V and 1 V to 3.0 V all showed minor activation phenomena compared with the performance of PS-TNT.

FIG. 2 shows electrochemical performance of the PS-TNT as anode tested at 0.01-3 V. (a) The cycling performance of the PS-TNT nanotubes at different testing rate: (i) rate dependent performance at 2, 4, 10, 20 C, (ii) rate performance at 60 C, (iii) rate performance at 2 C (1 C=175 mAg⁻¹). (b) The discharge profile of the PS-TNT at the first cycle and 10000 cycles. When dividing the capacity of PS-TNT cell into 0.01 to 1.0 V region and 1.0 to 3.0 V region, it is found that 0.01 V to 1.0 V region dominated the capacity after 10000 cycles. (c) the correlation between the exact charging time with the charging capacity. (d) The correlation of the charging capacity with the different charging rates (1 C=175 mAg⁻¹). The electrochemical performance of PS-TNT cell at different rate were evaluated to monitor the activation process. It is found that the capacity of 2 C reached the highest capacity of 1200 mAhg⁻¹ at around 800th cycle. As the rate increased, the peak capacity decreased and the cycle number at peak capacity increased.

FIG. 3 shows (a) Post electrochemical performance of PS-TNT after 10110 cycles testing; (b) Charging-discharging voltage profiles of PS-TNT after 10110 cycles testing; (c) Correlation of the charge time with the charging capacity.

FIG. 4 shows TEM image of the PS-TNT after cycling (a-b) The low magnification TEM image of the PS-TNT after 10000 cycles testing. The (b) image is taken from the square in (a). The (c) and (d) high magnification TEM are taken from the (I) and (II) in (b) respectively. The (e-h) are taken from the scanning transmission electron microscopy (STEM) mode: (e) STEM image, (b) Energy-dispersive X-ray spectroscopy (EDX), (g) Ti element mapping; (h) O element mapping.

FIG. 5 shows evolution of the PS-TNT during the high rate cycling. (a) the evolution of step activation of the PS-TNT with the cycling numbers; (b) the XRD pattern of the as-prepared PS-TNT and after 10000 cycles testing. (c) EIS spectra (impedance plots) of the PS-TNT after different cycle numbers. The cycle number was labeled from FIG. 5(a). The X axis is the real impedance (Z′) and the Y axis is the imaginary impedance (Z″). To better monitor the capacity activation process of PS-TNT cell, the cell was cycled every 60 C for 1000 cycles and followed by 2 C for 5 cycles. There is a gradual increase of 2 C capacity from 160 mAhg⁻¹ at initial state to 900 mAhg⁻¹ at 11000th cycle.

FIG. 6 shows TEM images of the as-prepared PS-TNT taken at (a-b) low and (c) high magnifications.

FIG. 7 shows TEM images of the as-prepared PS-TNT after 10000 cycling taken at different positions on the copper grid.

FIG. 8 shows charging and discharging profile of the PS-TNT, indicating the appearance of anatase TiO₂ and TiO₂-B.

FIG. 9 shows effect of the carbon species (polystyrene sphere, carbon nanotube (CNT), reduced graphene oxide (GO)) on electrochemical performance of TNT obtained after annealing.

FIG. 10 shows high-resolution XPS spectra of Ti 2p peaks for the (a) as-prepared PS-TNT sample discharged to 1V and (b) 10000 times cycled PS-TNT sample discharged to 0.01 V; (c) X-ray absorption near edge structure (XANES) spectra of Ti:K edge for as-prepared PS-TNT sample (black line), PS-TNT sample cycled between 1-3V (red line) and PS-TNT samples cycled between 0.01-3V (blue line); (d) First derivative of absorbance with respect to X-ray energy for the XAS spectra of three samples in (c); (e) Bulk mode XAS spectra of Ti L-edge for PS-TNT samples at different cycling stages.

FIG. 11 shows (a) Capacity comparison of two different charge-discharge mode. Mode I: Cell is charged at high rate (7.5 A/g) and discharged at low rate (0.25 A/g); Mode II: Cell is charged at low rate (0.25 A/g) and discharged at high rate (7.5 A/g). (b) Voltage profiles of the two charge-discharge modes with respect to time snapshotted at the 50th and 950th cycle, respectively. (c-d) Capacity comparison of (c) actived PS-TNT and (d) unactivated PS-TNT assembled in a full cell, commercial LiFeO₄ is employed as the cathode.

FIG. 12 shows ex-situ XRD pattern of the PS-TNT after 10000 cycles under the discharge condition from 3.0 V (D 3V) to 0.01 V (D 0.01V), and charge to 0.5 V (C 0.5 V) and 1.0 V (C 1V).

FIG. 13 shows (a) in-situ XAFS to determine the valence state for the fresh PS-TNT and the (b) ex-situ XAFS to determine the valence state for the PS-TNT after 10000 cycles.

FIG. 14 shows the cycling evolution of valence change for the Ti K-edge energy shift during the activation.

FIG. 15 shows the effect of varying weight ratio of carbon to TNT on the activation process.

FIG. 16 shows the role of carbon species in the activation process of TNT incorporated with various carbon species.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

It is known that for the intercalation of TiO₂ materials, the lithiation potential is higher (>1.5 V) with a capacity less than 335 mAhg⁻¹ under a lithiation potential of 1.0 to 3.0 V. When the lithiation potential is down to 0.01 to 3.0 V, the increase of capacity is not significant due to the limited surface storage, and the activation or the step increase of the capacity with the cycling is not observed in the TiO₂ system. Similarly, it is also found that pure TiO₂ nanotubes do not have big difference for the operating lithiation potential for 1.0 to 3.0 V and 0.01 to 3.0 V.

According to one aspect of the disclosure, a titanium dioxide (TiO₂) nanostructure for use as an electrode component in a lithium-ion battery is described. The electrode component may be formed by charging and discharging the TiO₂ nanostructure in an electrochemical cell from a high voltage of 1.0 to 3.0 V to a low voltage of 0.01 to 3.0 V at a charging rate of 2 to 100 C, wherein 1 C represents 175 mA/g.

The technical effect brought about by the cycling of the electrode lies in the disruption or rupture in the crystalline structure of the TiO₂ nanostructure, which leads to the extraordinary charge storage capacity of the nanostructure. Specifically, when the lithiation potential is down to 0.01 to 3.0 V, the increase of capacity is significant and the activation or the step increase of the capacity with the cycling can be observed in the present TiO₂ nanostructure system.

In one exemplified embodiment, it is discovered the progressive increase of battery capacity for a polystyrene-derived carbon/TiO₂ nanotubes hybrids (PS-TNT) from 90 mAhg⁻¹ to 300 mAhg⁻¹ for 10000 cycles at a high rate of 60 C (10.5 A/g), and the capacity is jumped to 1200 mAhg⁻¹ when the current density was returned to 2 C (0.35 A/g) with an operating window of 0.01 to 3.0 V. This performance is about 6 times higher than the initial capacity of the PS-TNT (220 mAhg⁻¹) at 2 C. This is a first report on the discovery on the extraordinarily reversible, stable and high capacity in TiO₂ category by achieving a massive lithium ion storage (3.6 Li⁺, Table 1) in TiO₂ nanostructures via breaking the rigid crystal structure (to be discussed later).

TABLE 1
Theoretical capacity for TiO₂ polymorphs.

| | | | Number of |
|---|---|---|---|
| Anode material | Theoretical capacity | | Li⁺ storage |
| Rutile TiO₂ | 33.5 | mAh/g | 0.1 |
| Anatase TiO₂ | 167 | mAh/g | 0.5 |
| TiO₂—B | 335 | mAh/g | 1 |
| Present TiO₂ nanotube | 800-1500 | mAh/g | 2.4~4.5 |

By the term “TiO₂ nanostructure”, it is meant that a structure that is composed of TiO₂ and is in nano-scale. The nanostructure may be of any configuration, such as, a nanotube, nanorod, nanowire, nanoflower, nanoflake, or nanoparticle.

In preferred embodiments, the TiO₂ nanostructure may be in a form of nanotube having a high length/diameter (L/D) aspect ratio and a hollow core. Such a configuration affords high surface area for attachment of functional groups, such as, a carboxylic group for functionalization of the nanotube.

In various embodiments, the electrode component is comprised of a plurality of TiO₂ nanostructures.

In various embodiments, prior to the charging and discharging process, the TiO₂ nanostructures may include a plurality of conductive carbonaceous particles attached thereto. By attaching the plurality of conductive carbonaceous particles to the TiO₂ nanostructures, the reaction rate of the activation process can be promoted or accelerated, mainly due to an increase in the electronic conductivity and the formation of stable solid-electrolyte interfaces.

By “carbonaceous particle” is meant a carbon-containing particle. The carbonaceous particles may be derived from a conductive carbon species or a conductive carbon-based material.

In various embodiments, the conductive carbon species or the conductive carbon-based material may include polystyrene, carbon nanotube, or reduced graphene oxide, and thermal-derived conductive carbon materials from various precursor materials or any conducting carbon species (for example, metal-organic frameworks (MOF, sugar, etc.).

In preferred embodiments, the conductive carbon species or the conductive carbon-based material may include polystyrene.

As mentioned in earlier paragraphs, the charging and discharging cycling process involves the rupture of the crystalline structure of the TiO₂ nanostructures. Accordingly, prior to the charging and discharging process, the TiO₂ nanostructure may be comprised of a crystalline phase, such as (i) an anatase phase, or (ii) a TiO₂-bronze phase. Alternatively, prior to the charging and discharging process, the TiO₂ nanostructure may be comprised of an amorphous phase. For the amorphous TiO₂ nanostructures, the self-activation may occur in the same operation window as the PS-TNT. The self-activation performance may be improved with the addition of any conductive carbon species. After activation, the amorphous TiO₂ phase may be maintained.

In various embodiments, after the charging and discharging process, the TiO₂ nanostructure may be comprised of a crystalline phase and an amorphous phase. In one example, the TiO₂ nanostructure may be comprised of an inner crystalline phase and an outer amorphous phase, wherein the outer amorphous phase surrounds at least a portion of the inner crystalline phase. By “at least a portion” is meant that the outer amorphous phase may surround partially or completely the inner crystalline phase. The inner crystalline phase may be comprised of an anatase phase.

The electrode thus formed by the charging and discharging cycling process of the TiO₂ nanostructures may be assembled in a lithium-ion electrochemical cell. The lithium-ion electrochemical cell may include a first electrode and a second electrode separated by an electrolyte, wherein one of the first and second electrodes may include the TiO₂ nanostructures described above.

A plurality of lithium-ion electrochemical cells described above may be electrochemically linked to form a lithium-ion battery.

In order that the invention may be readily understood and put into practical effect, particular embodiments will now be described by way of the following non-limiting example.

### EXAMPLES

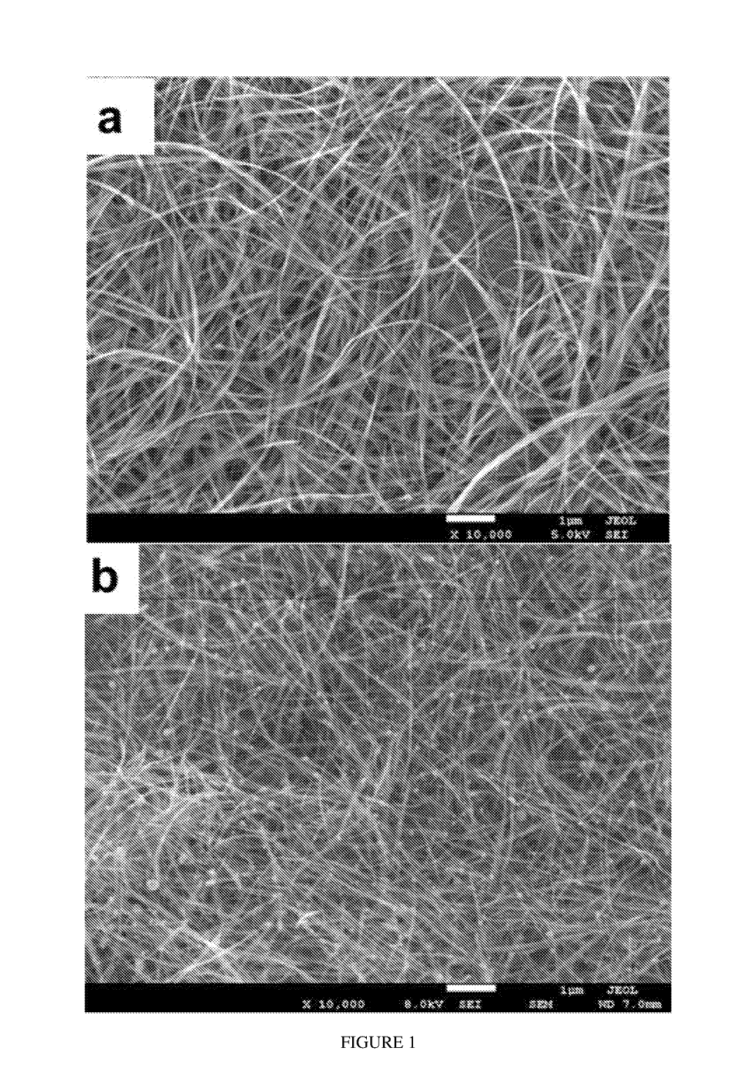

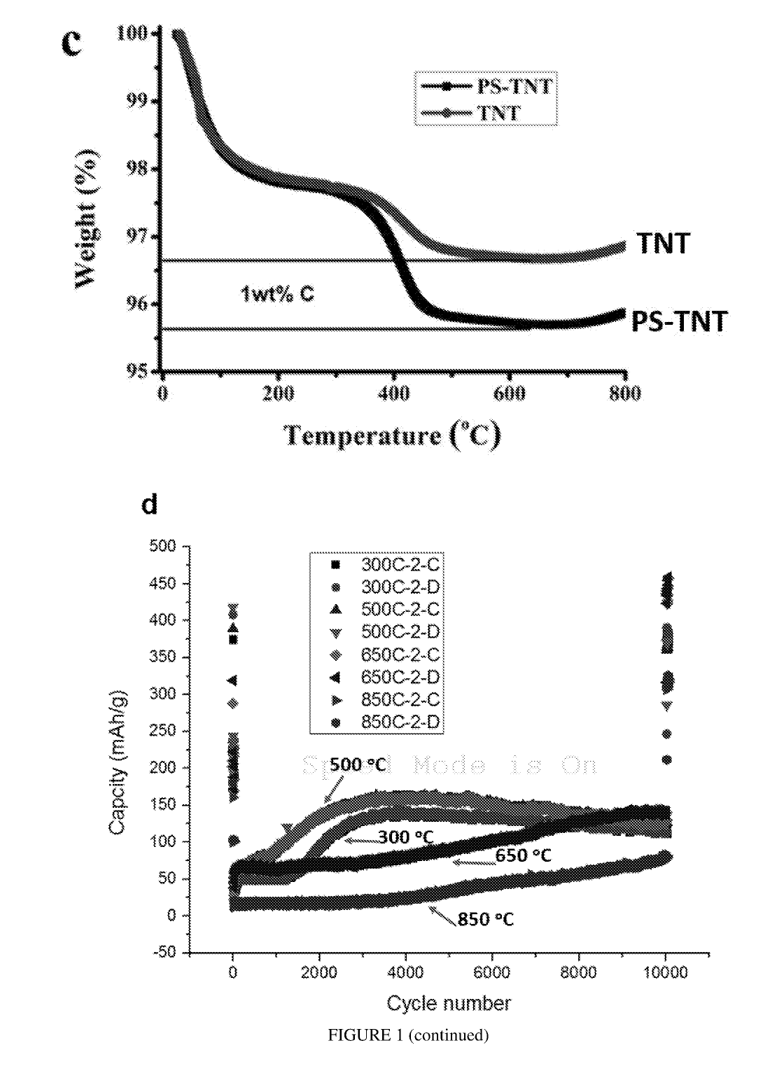

Anode materials were prepared as follows. Firstly, titanium dioxide nanostructures, such as but not limited to, titanate nanotubes (TNT), were synthesized by known stirring hydrothermal process with nanotube diameter and length around 100 nm and 30 μm (FIG. 1(a)). TNT gel (4 mg/mL) was synthesized from a stirring-hydrothermal protocol. Polystyrene latex microspheres were mixed with TNT gel at a volume ratio of 1:20. The mixture was stirred for 1 h and denoted as PS-TNT. The PS-TNT mixture was subsequently annealed at 750° C. for 2 h in a vacuum furnace. Alternatively, commercially available TNT may be used. In other words, the manner of forming the TNT does not significantly affect the target performance of the anode. Moreover, as mentioned in earlier paragraph, other configurations of suitable TiO₂ nanostructure besides nanotubes can be used, although it can be reasonably expected that the performance may be less superior due to smaller surface area, conductivity or other issues.

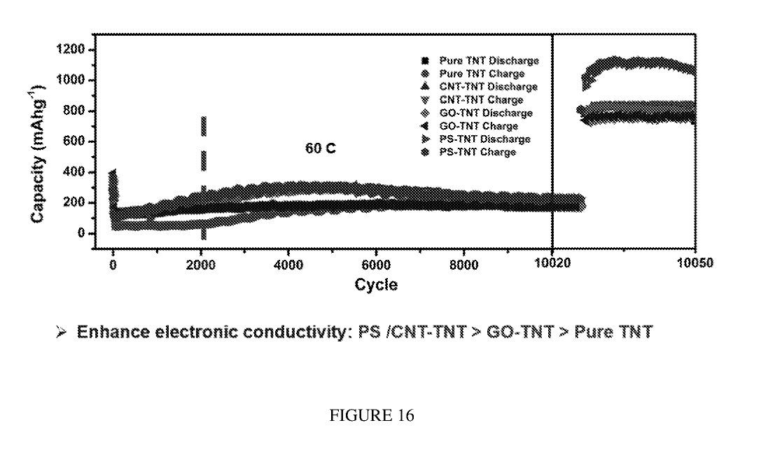

To study the role of carbon sources in the activation process, electrochemical performance of TNT incorporated with other carbon types (CNT-TNT, graphene oxide-TNT) are compared with PS-TNT as well as pure TNT. It is noted that PS-TNT showed the best performance after activation, while CNT-TNT, GO-TNT and pure TNT sustained the similar result (FIG. 16).

Secondly, a trace amount of conductive carbonaceous particles, for example, carboxylate-modified microspheres such as but not limited to, polystyrene (PS sphere), were added to the titanate nanotubes. The as-prepared PS sphere/titanate nanotubes were calcined in a vacuum furnace at a temperature of between 400 and 900° C., such as 750° C., for a duration of between 20 min and 5 hours, such as 2 hours, to obtain the PS-TNT hybrids materials. SEM images show that the PS spheres are evenly attached to the nanotubes by the virtue of carboxylic groups (FIG. 1(b)). X-ray diffraction (XRD) confirmed the existence of anatase TiO₂ and TiO₂-B crystallite, and the carbon content for the PS-TNT is around 1.0 wt % (FIG. 1(b)).

FIG. 1(d) shows the temperature-depended activation for the pure TNT without the PS particles. The result shows that activation occurs for different temperatures of pure TNT without the PS particles; however the activation rate is far slower than the PS-TNT product at the same temperature.

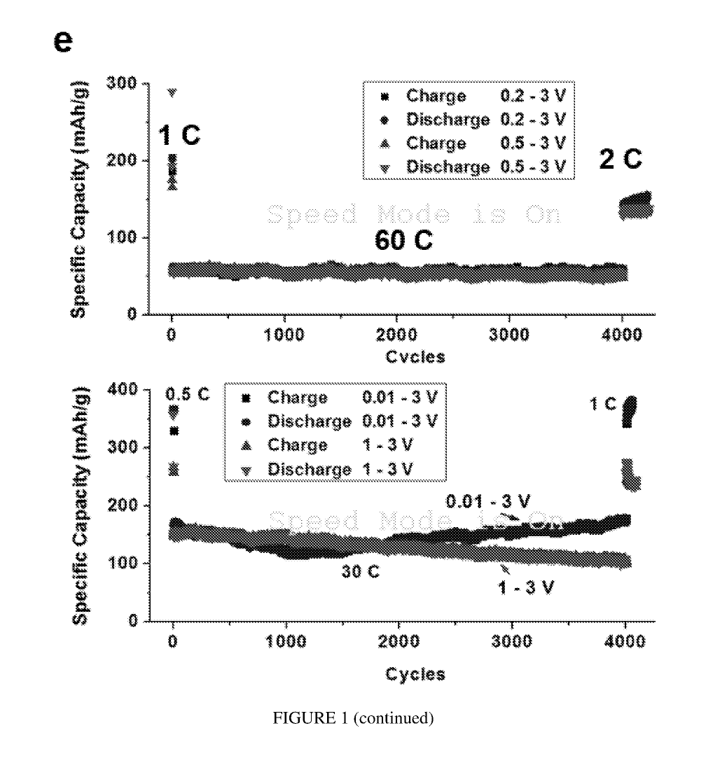

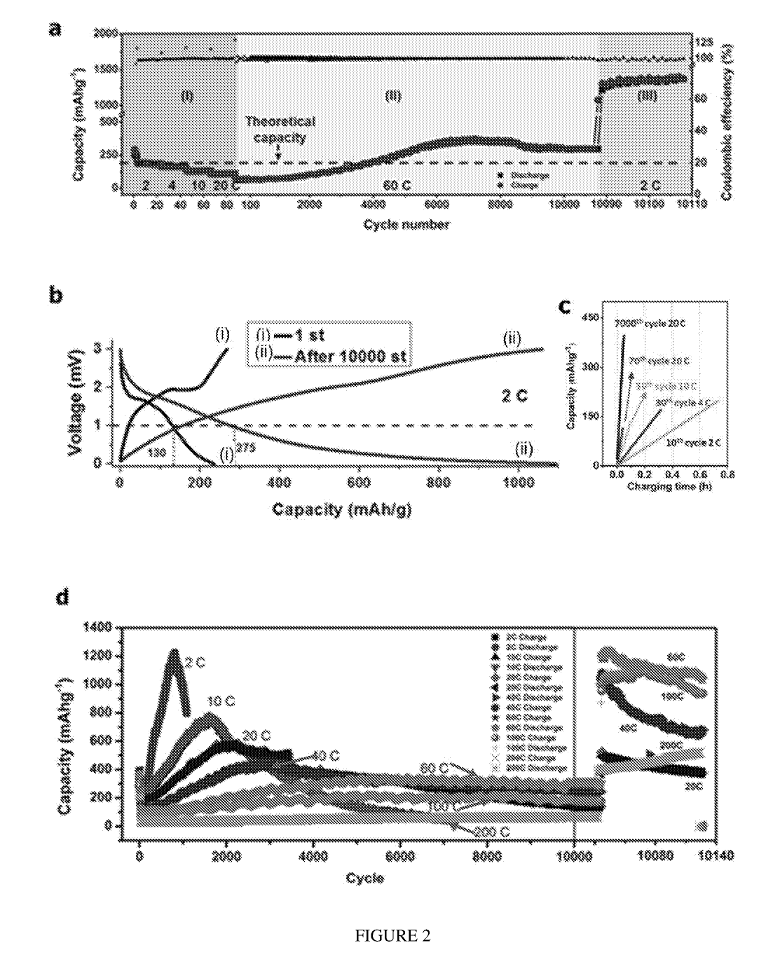

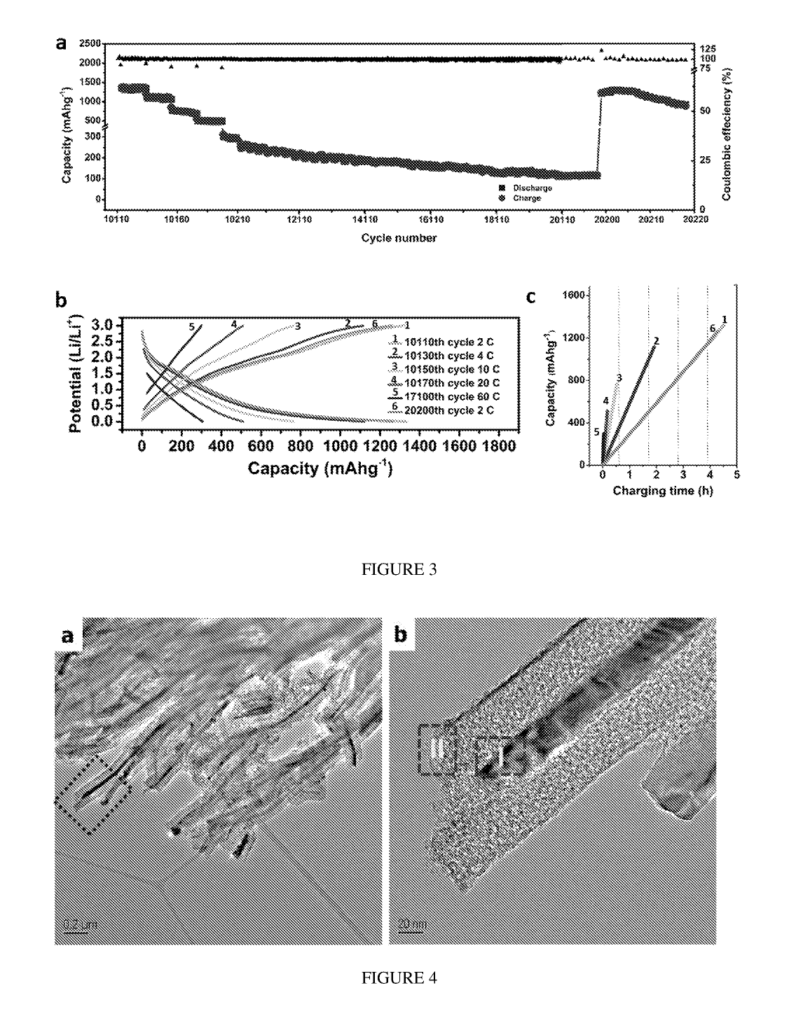

As a proof-of-concept, the performance of the binder-free PS-TiO₂ nanotubes hybrids as anode electrodes was evaluated (FIG. 2) as anode at 0.01-3 V for 10000 cycles at a current rate of 60 C (1 C=175 mAg⁻¹). In FIG. 2(a), it can be seen that the discharge capacity varies from 220, 150, 125, 102 and 90 mAhg⁻¹ with the increasing current rate from 2 C, 4 C, 10 C, 20 C to 60 C. Contrast to the traditional performance decay with the cycling numbers, it is found that there is a progressive increase of battery capacity for PS-TNT from 90 mAhg⁻¹ to 300 mAhg⁻¹ for 10000 cycles at a high rate of 60 C. Impressively, the capacity then increases back to 1200 mAhg⁻¹ when the current rate returns to 2 C, and this performance is about 6 times higher than of the initial capacity at 2 C. Furthermore, ultrahigh Coulombic efficiency value of nearly 100% can be obtained even when gradually increased current rates are applied. Even at ultra-high rate of 60 C (10.5 A/g), the capacity of this lithium-ion cell can reach around 300 mAhg⁻¹, exceeding the capacity of 220 mAhg⁻¹ at 2 C. To track the trend, consistency and lifetime of this battery electrode, another 10000 cycles were repeated on the same cell, it can be found that this 2^{nd} 10000 cycles greatly outperformed the initial 1^{st} 10000 cycles at low rate (FIG. 3). Upon cycling at 60 C, the capacity of this 2^{nd} 10000 cycles successively decreased, probably due to degradation and aging of the cell. However, despite this decline, the cell can still reach a capacity of 1000 mAhg⁻¹ after current rate was returned to 2 C again, indicating a much more lithium uptake ability at a low rate, bearing in mind at this stage the material of PS-TiO₂ nanotubes has been cycled for 20000 times.

It is found that this outstanding capacity for the PS-TNT after long-time cycling is originated from two regions (FIG. 2(b)): (a) 1.0 to 3.0 V, and (b) 0.01 to 1.0 V. For the as-prepared PS-TNT, the total capacity consists of 130 mAhg⁻¹ (1.0 to 3.0 V) and 90 mAhg⁻¹ (0.01 to 1.0 V). For the PS-TNT after cycling, the capacity consists of 275 (1.0 to 3 V) and 925 mAhg⁻¹ (0.01 to 1.0 V), which is around 10 times higher than the pristine PS-TiO₂ at the same lithiation potential. In addition, the correlation of the exact charging time with the charged capacity is illustrated in FIG. 2(c). Surprisingly, it is found the PS-TNT sample after 10000 cycling exhibits fast charging capability, which is faster than the fresh PS-TNT samples. To understand the step activation of PS-TNT with the charging rate, the correlation of the charging speed with the electrode performance is conducted (FIG. 2(d)). Under the different charging current densities, it is found that the step increase phenomenon has occurred. For the low charging rate (2 C), a sharp increase of the capacity is observed; while for the high charging rate (200 C), the increase of the capacity is less but it is observable. This is attributed to the total time activation for the PS-TNT. That is, at low charging rate, the lithium diffusion time is longer, which enables enough time for lithium ion insertion into the TiO₂ nanotubes. This will contribute to more activation in terms of the charging capacity with the short cycle number. While for the fast charging rate, the lithium ion diffusion time is shorter, which only results in surface storage at high rates. This fast charging and discharging process (≥100 C) may not influence the PS-TNT crystal structure, while the short/medium charging rate (2˜100 C) breaks the crystal structure for the anatase TiO₂ and TiO₂-B for the PS-TNT.

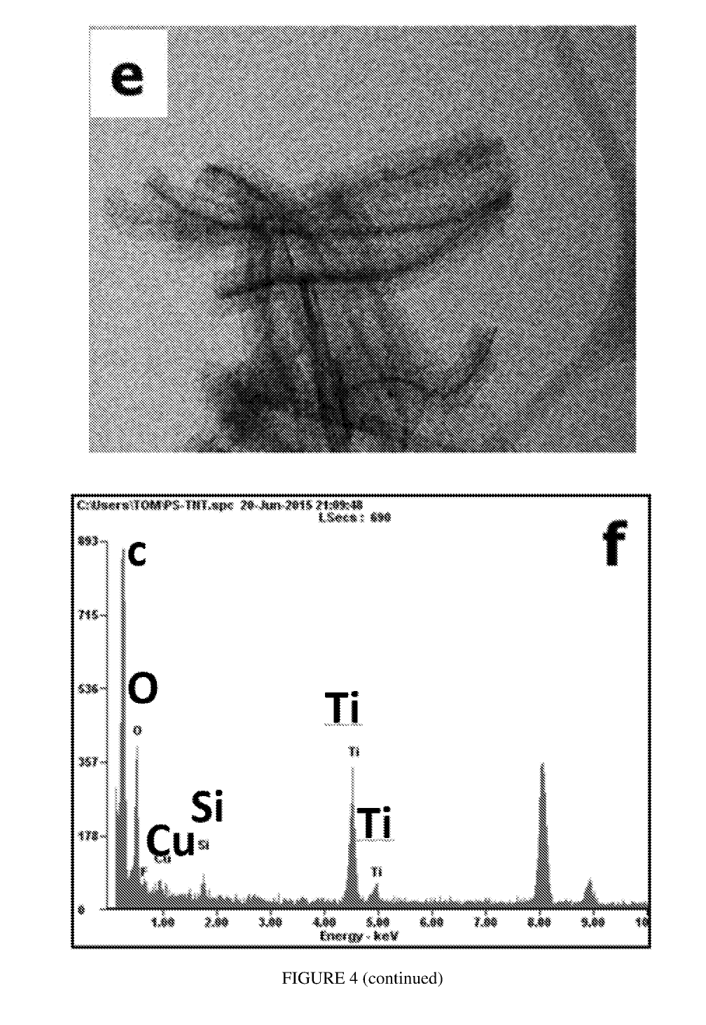

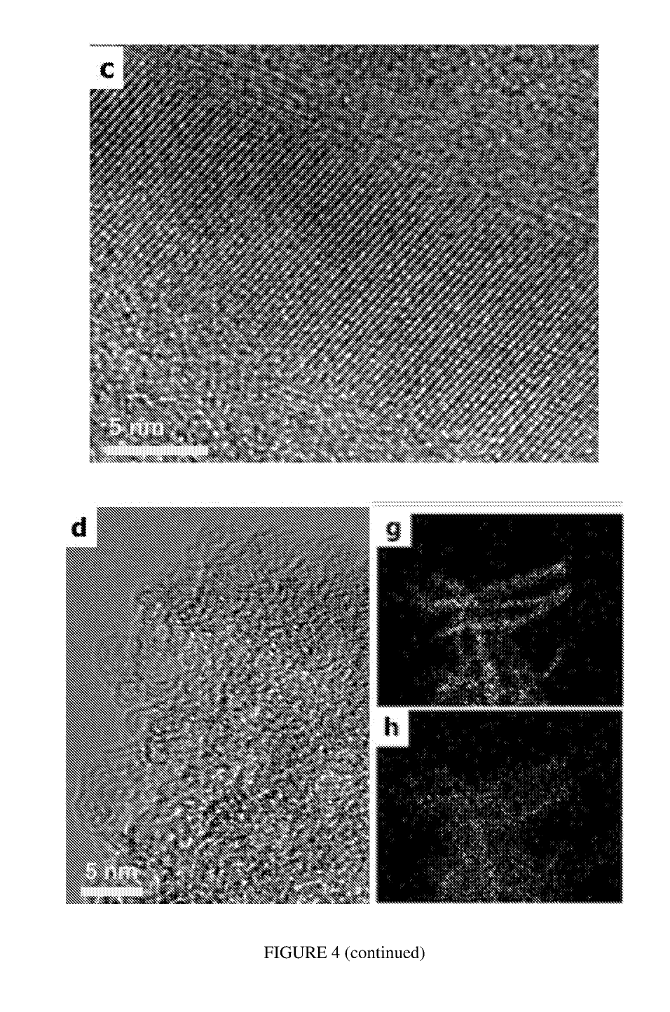

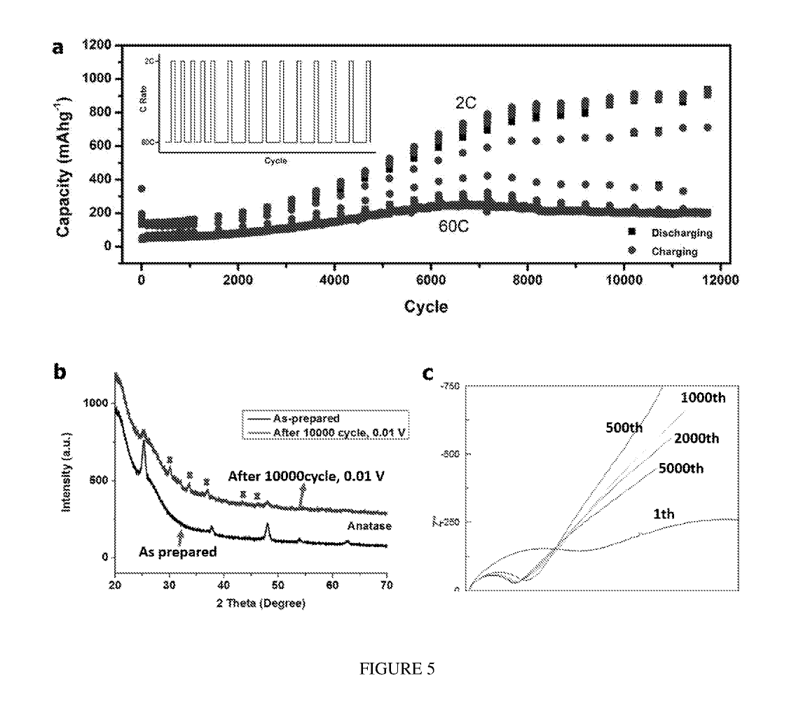

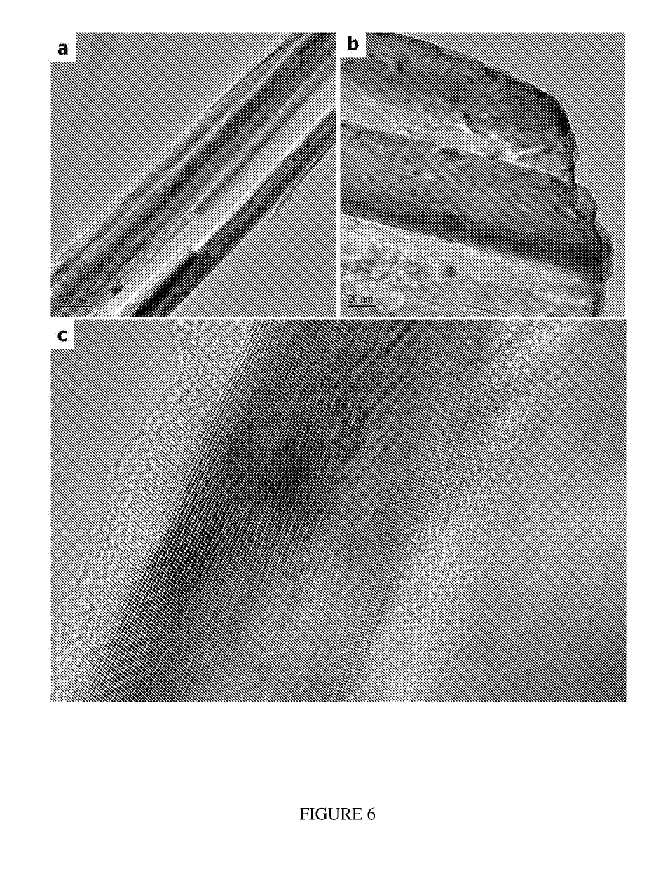

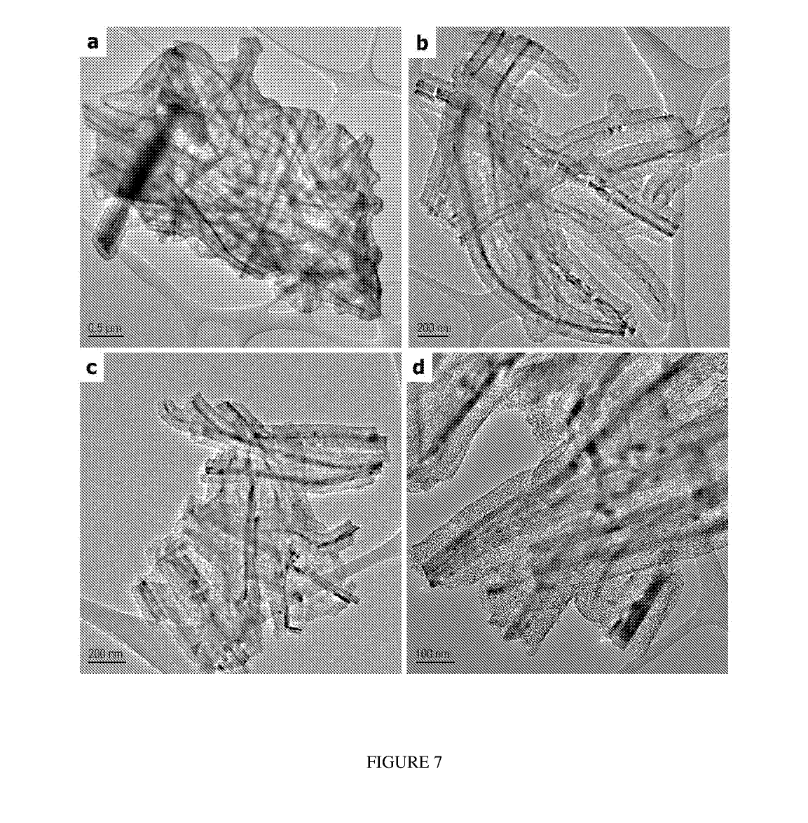

To understand the origination of this outstanding capacity for the PS-TNT after cycling, the morphology and crystal structures of PS-TNT before cycle and after cycling are evaluated (FIG. 4 and FIG. 5). Herein, the evolution of the activation of PS-TNT with the cycling number is shown in FIG. 5(a), and it is found that the step activation is quite obvious for the switching from high rate (60 C) to low rate (2 C), further proving the high activation of PS-TNT structures. For the pristine PS-TNT before cycling, the well crystalline of anatase phase of TiO₂ nanotube is observed (FIG. 6). Surprisingly, it is found that the mesopores core-shell structure (FIG. 7) is formed after long-time cycling. From the TEM image (FIG. 4(a)-(b)), the highly mesoporous structure is observed outside the solid nanowire. Herein, the core solid nanowire well maintains the crystal structure (FIG. 4(c)) while the outside porous structure is amorphous (FIG. 4(d)). The layered distance of 0.35 nm is the (101) plane of anatase phase of TiO₂ (FIG. 4(c)). From the scanning transmission electron microscopy (STEM) mapping data in FIG. 4(e)-(h), the composition of PS-TNT after cycling is mostly composed of titanium and oxygen elements. Moreover, the STEM mapping data (FIG. 4(g)-(h)) indicates that the amorphous structure is also composed of titanium and oxygen. Therefore, it can be concluded that the final product of PS-TNT after long-time cycling is almost titanium oxide with the anatase phase and amorphous phase.

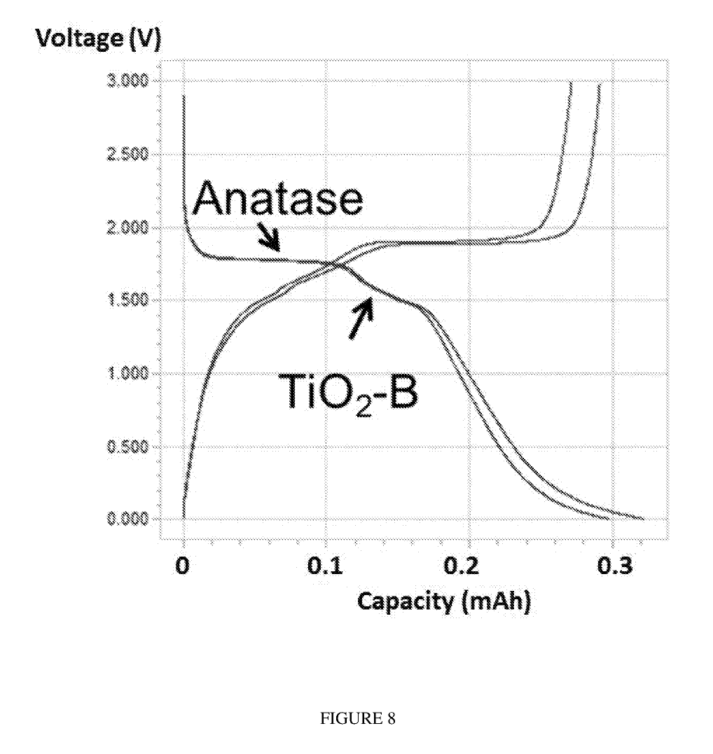

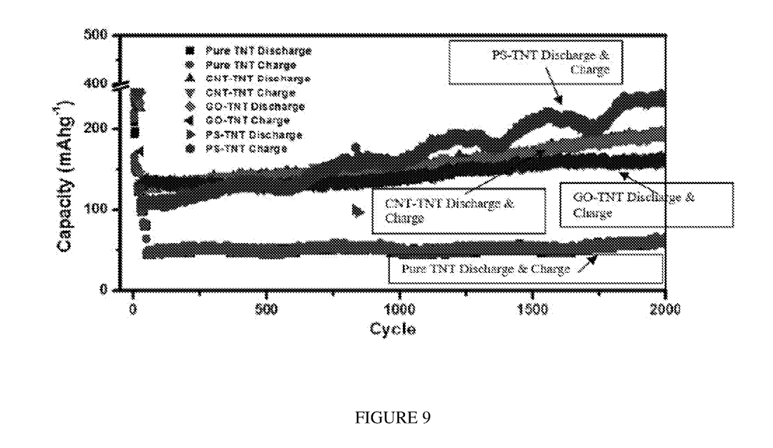

To further confirm this concept, it was conducted XRD measurement (FIG. 5(b)), and it is revealed the appearance of the anatase phase of TiO₂ for the pristine PS-TNT. It should be noted that the TiO₂-B is not observed due to the weak crystallite while it is detected by the CV measurement or the discharge profile (FIG. 8). After the long-time cycling, the crystalline phase is weak with the appearance of anatase phase, which is corresponding to the TEM result. The star peak marked in FIG. 5(b) belongs to the LiOH phase. Moreover, electrochemical impedance spectroscopy (EIS, FIG. 5(c)) revealed that the total resistance of the battery cell for the PS-TNT is decreased with cycling number (500 cycles to 5000 cycles). Moreover, the ionic conductivity is also improved. This is also contributing to the activation of PS-TNT during the cycling. Herein, it is found that the other carbon species, for example, polystyrene sphere, carbon nanotube (CNT), reduced graphene oxide (GO) also have the similar effect on the activation of TNT (FIG. 9). That is, the step increase of the capacity for the CNT-TNT, and GO-TNT is also enabled, which indicates the activation is promoted by the conductivity of the conductive carbon species. Therefore, any form of conductive carbon species or carbon-based compounds-derived carbon materials, or the conductive component are expected to be useful for the activation. Also, it is found that other morphologies of TiO₂, including but not limited to nanoparticles, nanorods, nanowires, nanoflowers, also have similar activation phenomenon.

The coverage of amorphous carbon (2-5 nm, FIG. 6) on the TNT almost reaches 100% due to the usage of titanate nanotube gel and the PS aqueous solution, which allows the formation of a uniform titanate nanotube/PS gel. Therefore, the PS uniformly coats on the TNT after annealing. The function of amorphous carbon derived from PS is to promote the activation process rate of TNT, and the activation is faster than the pure TNT.

Although the carbon coating (for example, by graphene or carbon nanotube) on TiO₂ is widely used, the activation process due to the operation voltage window from 1.0 to 3.0 V was not observed. However, when a new operation voltage window from 0.01 to 3.0 V is applied, the activation process occurred and was accelerated by the PS due to the uniform coating. Pure TNT do not observe a significant activation. Even for a mixture of carbon/TiO₂ materials, the activation is slow and not easily observed, but the present discovery is important to develop the high capacity of TiO₂ materials.

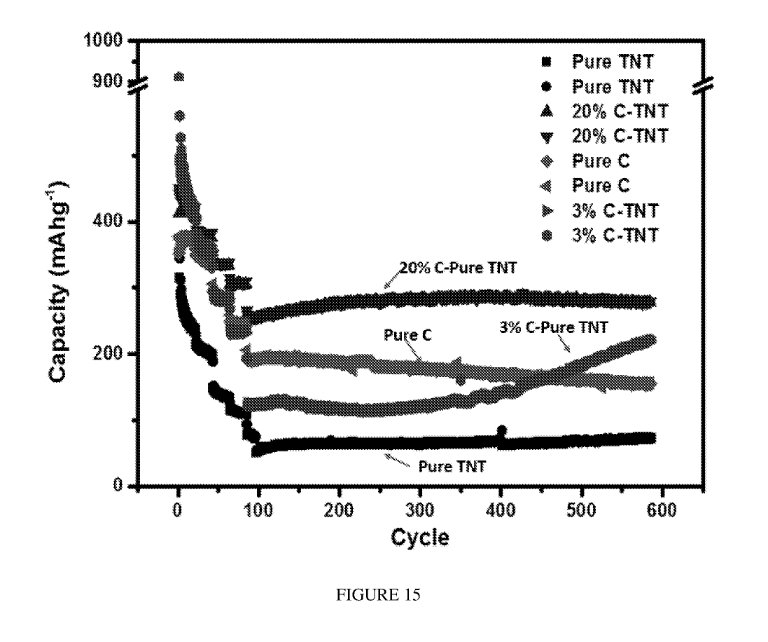

The effect of activation with the ratio of carbon to TNT is measured. For the PS-TNT, it is around 1%. With a 3 wt % of carbon, activation was observed, but with the increase of carbon content to 20 wt %, the activation is no longer significant (FIG. 15). Therefore, too many carbon source may block the lithium diffusion into the TiO₂, as well as the activation process for the TiO₂.

For the CNTs and reduced graphene oxide (RGO) on the TNTs, an elongated titanate nanotube gel with the water soluble CNT and RGO aqueous gel solutions were used. The mixture forms a uniform CNT/titanate gel or RGO/titanate gel, ensuring the close contact between the carbon source with TiO₂ after annealing. The weight ratio of CNT and RGO with TNT is 10 wt %. The annealing condition is the same as for PS-TNT.

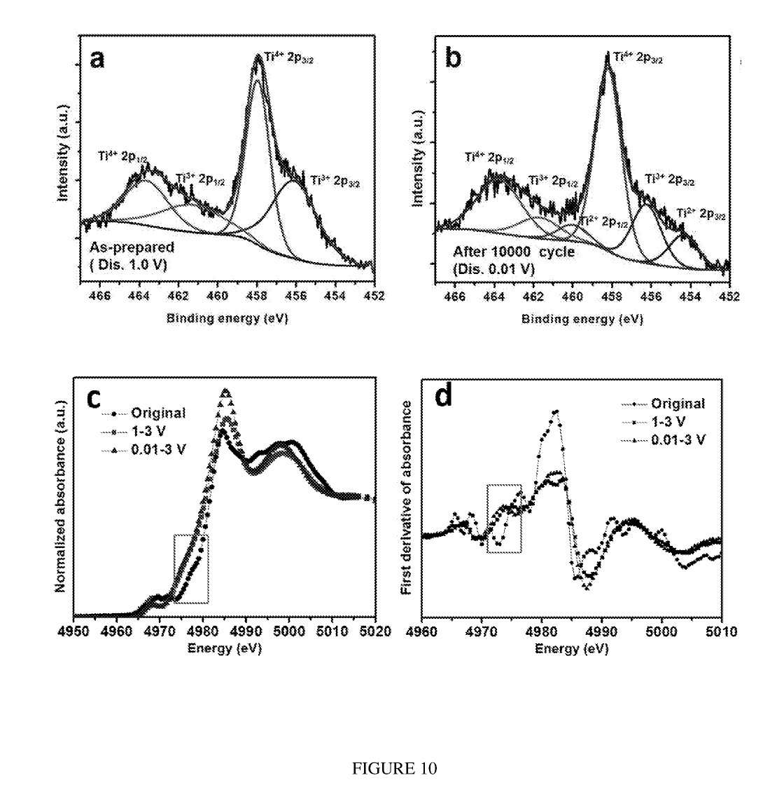

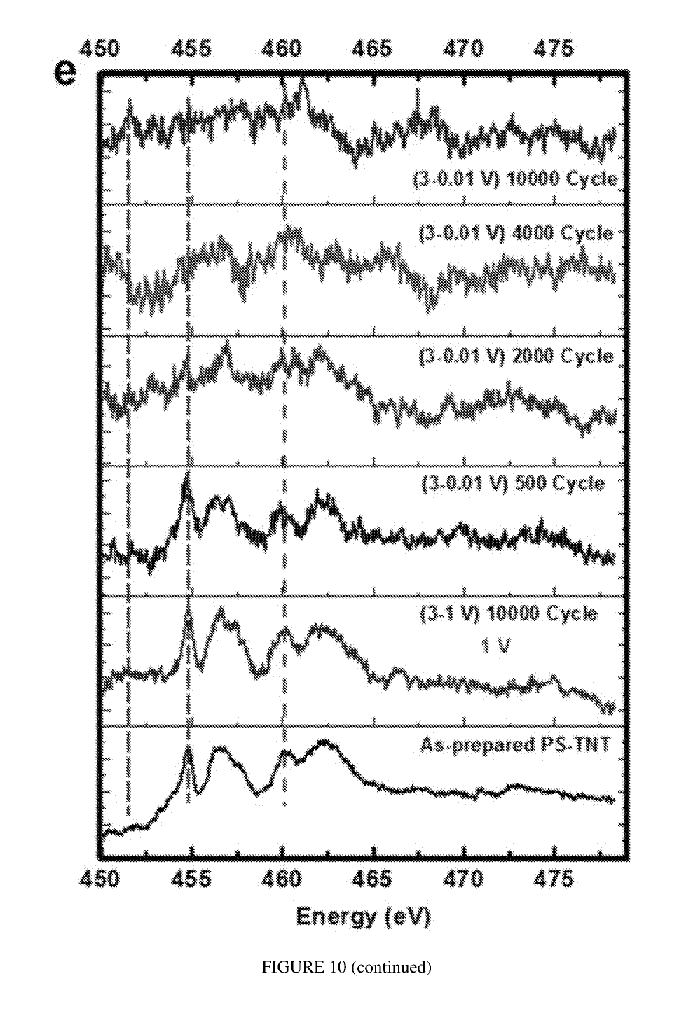

To track more detailed in-situ chemical changes in addition to structural evolution taken place on the PS-TiO₂ nanotubes when subjected to 10000 times cycling. X-ray photoelectron spectroscopy (XPS) and X-ray absorption spectroscopy (XAS) studies are performed on PS-TNT samples at different cycling phases and different charging/discharging states. As aforementioned in FIG. 2(b), most of the extra capacity (up to 80% of total value) stems from a potential region of 0.01-1 V, thus, if the TiO₂ host itself is presumably responsible for the extra capacity, a distinguishable chemical state difference of TiO₂ at 1 V and 0.01 V would be predictable. High-resolution XPS spectra of Ti 2p peaks revealed the valence states of Ti element before cycling discharged to 1 V (FIG. 10(a)) and after cycling discharged to 0.01 V (FIG. 10(b)). A broader shoulder aside Ti⁴⁺ 2p_{3/2} peak is located at lower energy is observable for samples after cycling discharged to 0.01 V compared to that before cycling discharged to 1 V. This broader shoulder can be assigned to Ti³⁺ 2p_{3/2} peak with a tiny Ti²⁺ 2p_{3/2} peak. This indicates the more electrons are stored (corresponding to the valence change of TiO₂) when discharging to 0.01 V. In a continued XAS survey, the absorption edge of Ti K-edge for the sample at 1 V is located at an energy position 3 eV higher than the original sample (at 3 V), indicating a Ti⁴⁺ to Ti³⁺ transition when samples are discharged from 3 V to 1 V. On the other hand, there is no observable edge shift when the sample is further discharged from 1 V to 0.01 V, but the interference pattern at XANES becomes stronger, indicating more Ti⁴⁺ to Ti³⁺ transitions taking place from 1 V to 0.01 V, which is consistent with XPS results that there is a continuous reduction of Ti⁴⁺ to Ti³⁺ rather than Ti⁴⁺ to Ti²⁺ or any other states as sample is discharged from 3 V to 0.01 V. However, even assuming all of the Ti⁴⁺ ions discharged to Ti³⁺ to accommodate Li⁺ ions (<335 mAh/g) and electrons, this cannot account for a capacity as high as 1200 mAhg⁻¹, indicating that the extra capacity is not from intrinsic TiO₂ chemical change or the conversion mechanism for the reduction of Ti⁴⁺ to Ti⁰.

Based on current understanding on the crystal structure and morphology, and the XPS and XAS surface analysis, it is excluded the conversion mechanism for the Ti⁴⁺ to Ti⁰ as the main reason behind the extra capacity. Therefore, it has been proposed this extremely high capacity (intercalation storage) is originated from two parts: the surface storage lithiation mechanism and the intercalation storage on the PS-TNT.

LiOH+2Li⁺+2e−=Li₂O+LiH (surface storage on PS-TNT)

TiO₂+xLi⁺+e=LiₓTiO₂ (intercalation storage on PS-TNT)

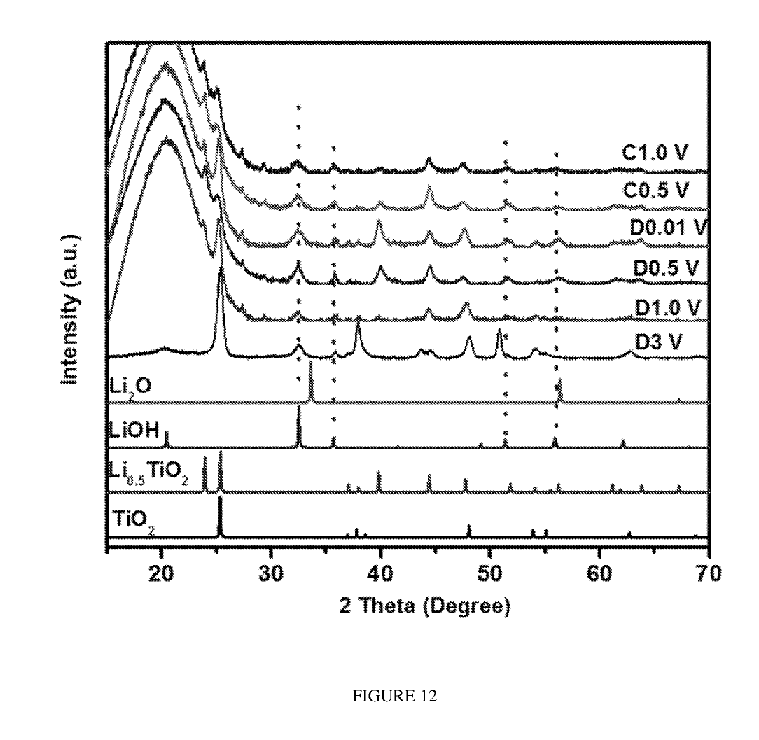

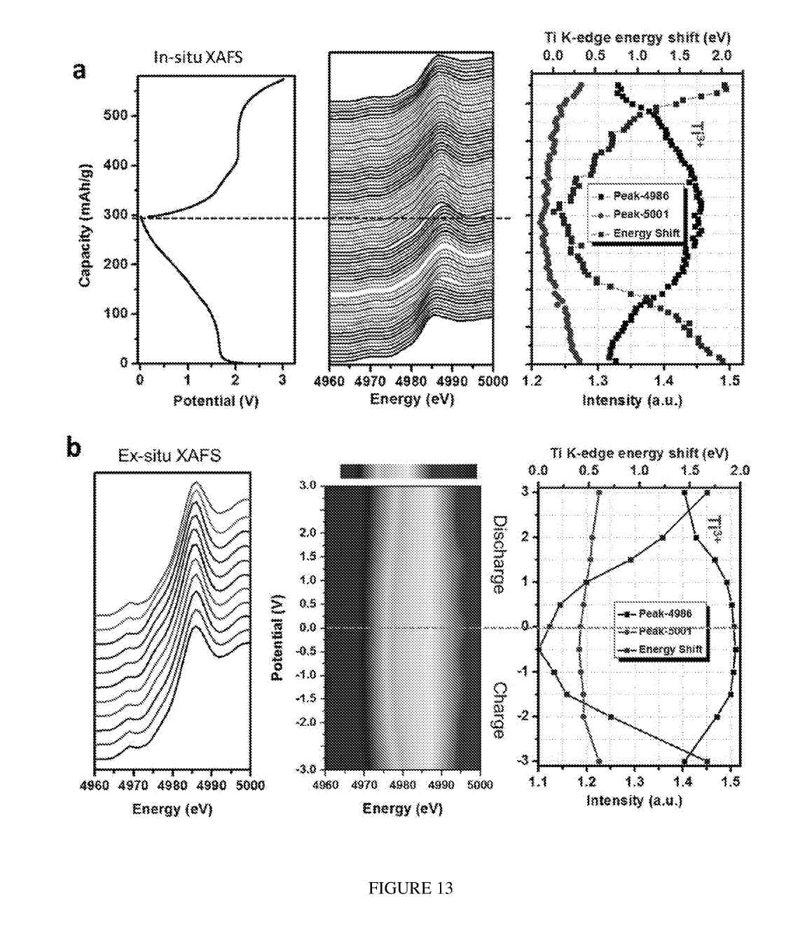

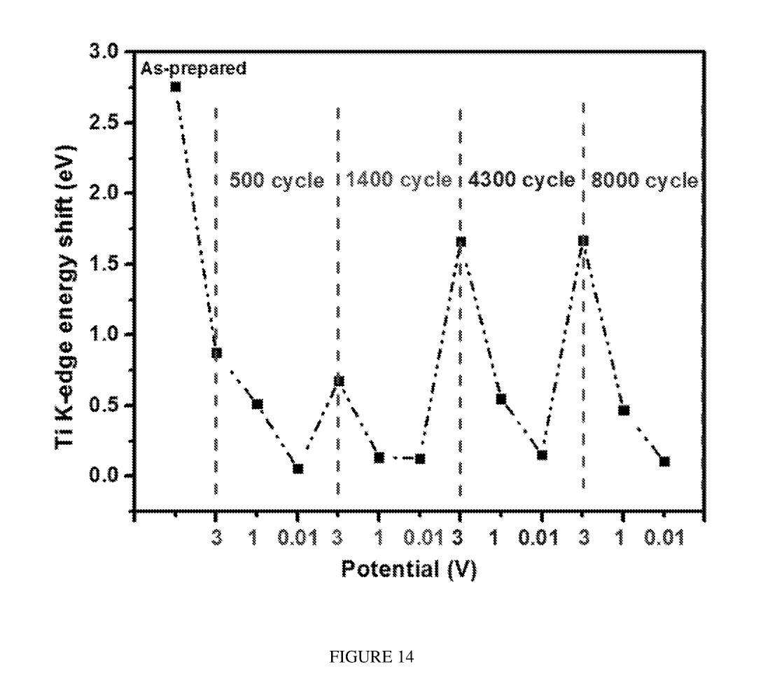

In the XRD pattern, it is observed the formation of LiOH formation (FIG. 12). This is first time report on the reversible reaction for the LiOH on the TiO₂ materials, and the high reversible capacity is originated from the extremely high theoretical capacity (2233 mAh/g). Although the intercalation storage can contribute to the final capacity, it is limited to the theoretical capacity (<335 mAh/g). From the data of in-situ monitoring of the valence change of PS-TNT before (FIG. 13(a)) and after 10000 cycle activation reaction (FIG. 13(b)), it is known that the valence change for the Ti⁴⁺ (corresponding to the Ti K-edge energy shift) has changed dramatically for the voltage from 3.0 V to 1.0 V, indicating the capacity is most from the intercalation reaction. For the voltage from 1.0 V to 0.01 V, the valence change for the Ti⁴⁺ is very minor. This indicates the capacity is mostly from the intercalation reaction. For the PS-TNT after 10000 cycling (FIG. 13(b)), it is observed that the similar valence change for the Ti⁴⁺ from the 3.0 V to 1.0 V, and the low voltage range is also similar to the as-prepared sample. This indicates the high capacity of PS-TNT after cycling is attributed from the low-voltage range, which does not change the valence state of the Ti⁴⁺. Moreover, it is found that the valence change for the Ti K-edge is changing during the activation process (FIG. 14), and the energy shift is increased after 4000 cycle. This means more reduction of Ti⁴⁺ after 4000 cycle, indicating the Ti⁴⁺ trapped in the beginning is reactive and participate in the lithiation process. This also will contribute to the high capacity. More experiments are being carried out currently to prove the reversible reaction for the surface storage.

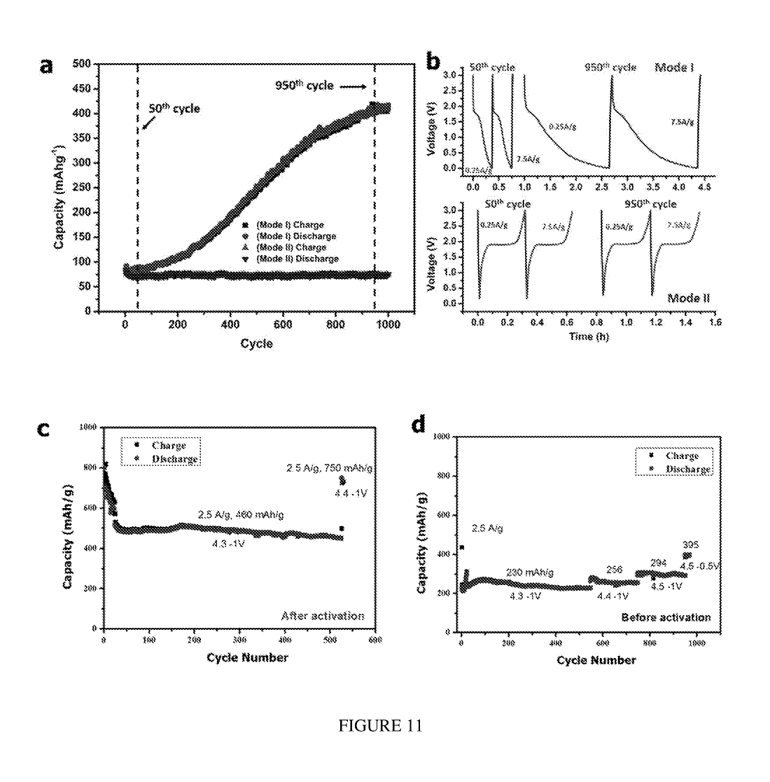

To simulate the real scenario of daily battery using condition, two different charge-discharge modes are programmed to evaluate the capacity performance of PS-TNT in an instance where charging and discharging rates are essentially different (FIG. 11(a)-(b)). In mode I the cell is charged at a current rate of 7.5 A/g (corresponding to a real-time rate of XC) while discharged at 0.25 A/g (XC). On the other hand, in mode II the cell is charged at 0.25 A/g and discharged at 7.5 A/g. What remains intriguing is that these two modes exhibited significant deviation as the testing proceeds to 1000 cycles. In mode I there is a continuous capacity increase from 90 mAhg⁻¹ (50th cycle) to 406 mAhg⁻¹ (950th cycle), whereas in mode II there is a flat capacity performance of 74 mAhg⁻¹ with no noticeable increase or decrease. Indeed, from an electrochemical perspective, mode I refers to a slow Li⁺ ion intercalation process but followed by a fast and immediate extraction process, it is evident that the intercalation of Li⁺ ions into TiO₂ (discharge process) will exactly determine the overall capacity, and these intercalated ions can be deintercalated (charge process) at a much faster rate without compromising capacity. On the contrary, when the charge/discharge rates are reversed (mode II), the capacity remains at a smaller value of 74 mAhg⁻¹, which is due to an overly fast intercalation process (a real-time rate of 90 C). In fact, performance of mode I is analogous to that of charging/discharging at 1 C while mode II is similar to that of 30 C (FIG. 2), which is reasonable considering the intercalation kinetics exactly determines the overall capacity, as a result, the capacity increasing mechanism of mode I is the same as the activation process of charging/discharging at 1 C. The activation of mode II is much slower due to fast intercalation process, making it not observable at first 1000 cycles. To further confirm the applicability and versatility of this extra capacity derived from reversible lithium hydroxide reaction, the capacity performance of activated PS-TNT in a full cell is also demonstrated (FIG. 10(c)-(d)). It is evident that the full cell composed of activated PS-TNT could outperform that of unactivated PS-TNT when tested in the same potential window (4.3-1V) and current rate (2.5 Ag⁻¹), with the capacity of activated PS-TNT being 460 mAhg⁻¹ and unactivated PS-TNT being 230 mAhg⁻¹. The outperformance of activated PS-TNT would stem from enriched chemical environment for lithium hydroxide reaction to take place in the ultralong TiO₂ nanotubes. The fresh PS-TNT, on the other hand, produced relatively poorer performance due to the lack of lithium hydroxide species. It is also noticeable that the activated capacity of the full cell (460 mAhg⁻¹) is not as high as that achieved in half cell (1200 mAhg⁻¹), which is reasonably accepted given that the commercial LiFeO₄ as cathode would be a limiting factor for capacity. It should also be noted that, in order to fully utilize the activated capacity of PS-TNT in a commercial full cell prototype, more sophisticated controls and optimizations on parameters such as best activation phase and voltage window selection are required to follow up.

In summary, it is herein discovered the progressive increase of battery capacity for a PS-TNT from 90 mAhg⁻¹ to 300 mAhg⁻¹ for 10000 cycles at a high rate of 60 C (10.5 A/g), and the capacity is jumped to 1200 mAhg⁻¹ when the current density was returned to 2 C (0.35 A/g) with an operating window of at 0.01 to 3 V. This performance is about 6 times higher than the initial capacity of the PS-TNT (220 mAhg⁻¹) at 2 C. It has been proposed this extremely high capacity is originated from two parts: the dominated surface lithiation storage (LiOH+2Li⁺+2e−=Li₂O+LiH) and the minor intercalation storage on the PS-TNT (intercalation storage: TiO₂+xLi⁺+e=LiₓTiO₂). This is the first time report on the discovery of the extraordinarily reversible, stable and high capacity in TiO₂ category by achieving the massive lithium ion storage (3.6 Li⁺, Table 1) in TiO₂ nanostructures via breaking the rigid crystal structure.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### REFERENCES

1. Kang, K.; Meng, Y. S.; Bréger, J.; Grey, C. P.; Ceder, G. Electrodes with High Power and High Capacity for Rechargeable Lithium Batteries. Science 2006, 311, 977-980.
2. Park, M. H.; Kim, K.; Kim, J.; Cho, J. Flexible Dimensional Control of High-Capacity Li-Ion-Battery Anodes: From OD Hollow to 3D Porous Germanium Nanoparticle Assemblies. Adv. Mater. 2010, 22, 415-418.
3. Oh, S. W.; Myung, S. T.; Oh, S. M.; Oh, K. H.; Amine, K.; Scrosati, B.; Sun, Y. K. Double Carbon Coating of LiFePO4 as High Rate Electrode for Rechargeable Lithium Batteries. Adv. Mater 2010, 22, 4842-+.
4. Van der Ven, A.; Bhattacharya, J.; Belak, A. A. Understanding Li Diffusion in Li-Intercalation Compounds. Acc. Chem. Res. 2012, 46, 1216-1225.
5. Lin, F.; Markus, I. M.; Nordlund, D.; Weng, T.-C.; Asta, M. D.; Xin, H. L.; Doeff, M. M. Surface reconstruction and chemical evolution of stoichiometric layered cathode materials for lithium-ion batteries. Nat. Commun. 2014, 5, 3529.
6. He, M.; Kravchyk, K.; Walter, M.; Kovalenko, M. V. Monodisperse Antimony Nanocrystals for High-Rate Li-ion and Na-ion Battery Anodes: Nano versus Bulk. Nano Lett. 2014, 14, 1255-1262.
7. Weng W.; Sun, Q.; Zhang, Y.; He, S.; Wu, Q.; Deng, J.; Fang, X.; Guan, G.; Ren, J.; Peng, H. A Gum-Like Lithium-Ion Battery Based on a Novel Arched Structure. Adv. Mater. 2015, 27, 1363-1369.
8. Wu, C.; Lu, X.; Peng, L.; Xu, K.; Peng, X.; Huang, J.; Yu, G.; Xie, Y. Two-dimensional vanadyl phosphate ultrathin nanosheets for high energy density and flexible pseudocapacitors. Nat. Commun. 2013, 4, 2431.
9. Zhao, Y.; Liu, B.; Pan, L.; Yu, G. 3D nanostructured conductive polymer hydrogels for high-performance electrochemical devices. Energy Environ. Sci. 2013, 6, 2856-2870.
10. Goodenough, J. B.; Park, K. S. The Li-Ion Rechargeable Battery: A Perspective. J. Am. Chem. Soc. 2013, 135, 1167-1176.
11. Chen, Z. H.; Belharouak, I.; Sun, Y. K.; Amine, K. Titanium-Based Anode Materials for Safe Lithium-Ion Batteries. Advanced Functional Materials 2013, 23, 959-969.
12. Ren, H.; Yu, R. B.; Wang, J. Y.; Jin, Q.; Yang, M.; Mao, D.; Kisailus, D.; Zhao, H. J.; Wang, D. Muftishelled TiO₂ Hollow Microspheres as Anodes with Superior Reversible Capacity for Lithium Ion Batteries. Nano Letters 2014, 14, 6679-6684.
13. Zhang, Y.; Jiang, Z.; Huang, J.; Lim, L. Y.; Li, W.; Deng, J.; Gong, D.; Tang, Y.; Lai, Y.; Chen, Z. Titanate and titania nanostructured materials for environmental and energy applications: a review. RSC Adv. 2015, 5, 79479-79510.
14. Zhang, Y. Y.; Tang, Y. X.; Yin, S. Y.; Zeng, Z. Y.; Zhang, H.; Li, C. M.; Dong, Z. L.; Chen, Z.; Chen, X. D. Hierarchical protonated titanate nanostructures for lithium-ion batteries. Nanoscale 2011, 3, 4074-4077.
15. Chen, Z.; Belharouak, I.; Sun, Y. K.; Amine, K. Titanium-Based Anode Materials for Safe Lithium-Ion Batteries. Adv. Funct. Mater. 2013, 23, 959-969.
16. Liao, J. Y.; Manthiram, A. Mesoporous TiO₂—Sn/C Core-Shell Nanowire Arrays as High-Performance 3D Anodes for Li-Ion Batteries. Adv. Energy Mater 2014, 4, 8.
17. Dylla, A. G.; Henkelman, G.; Stevenson, K. J. Lithium Insertion in Nanostructured TiO₂(B) Architectures. Acc. Chem. Res. 2013, 46, 1104-1112.
18. Reddy, M. V.; Subba Rao, G. V.; Chowdari, B. V. R. Metal Oxides and Oxysalts as Anode Materials for Li Ion Batteries. Chem. Rev. 2013, 113, 5364-5457.
19. Cai, D.; Lian, P.; Zhu, X.; Liang, S.; Yang, W.; Wang, H. High specific capacity of TiO₂-graphene nanocomposite as an anode material for lithium-ion batteries in an enlarged potential window. Electrochim. Acta 2012, 74, 65-72.
20. Wang, H.; Ma, D.; Huang, X.; Huang, Y.; Zhang, X. General and Controllable Synthesis Strategy of Metal Oxide/TiO₂ Hierarchical Heterostructures with Improved Lithium-Ion Battery Performance. Sci. Rep. 2012, 2, 701.
21. Tang, Y.; Zhang, Y.; Deng, J.; Wei, J.; Tam, H. L.; Chandran, B. K.; Dong, Z.; Chen, Z.; Chen, X. Mechanical Force-Driven Growth of Elongated Bending TiO₂-based Nanotubular Materials for Ultrafast Rechargeable Lithium Ion Batteries. Adv. Mater. 2014, 26, 6111-6118.
22. Tang, Y.; Zhang, Y.; Deng, J.; Qi, D.; Leow, W. R.; Wei, J.; Yin, S.; Dong, Z.; Yazami, R.; Chen, Z.; Chen, X. Unravelling the Correlation between the Aspect Ratio of Nanotubular Structures and Their Electrochemical Performance To Achieve High-Rate and Long-Life Lithium-Ion Batteries. Angew. Chem. Int. Ed. 2014, 53, 13488-13492.

1. A titanium dioxide (TiO₂) nanostructure for use as an electrode component in a lithium-ion battery, the electrode component being formed by charging and discharging the TiO₂ nanostructure in an electrochemical cell from a high voltage of 1.0 to 3.0 V to a low voltage of 0.01 to 3.0 V at a charging rate of 2 to 100 C, wherein 1 C represents 175 mA/g.

2. The TiO₂ nanostructure of claim 1, wherein prior to the charging and discharging process, the TiO₂ nanostructure comprises a plurality of conductive carbonaceous particles attached thereto.

3. The TiO₂ nanostructure of claim 2, wherein the plurality of conductive carbonaceous particles is derived from a conductive carbon species or a conductive carbon-based material.

4. The TiO₂ nanostructure of claim 3, wherein the conductive carbon species or the conductive carbon-based material comprises polystyrene, carbon nanotube, reduced graphene oxide, or thermal-derived conductive carbon materials from various precursor materials or any other conductive carbon species.

5. The TiO₂ nanostructure of claim 1, wherein prior to the charging and discharging process, the TiO₂ nanostructure is comprised of a crystalline phase.

6. The TiO₂ nanostructure of claim 5, wherein prior to the charging and discharging process, the TiO₂ nanostructure is comprised of (i) an anatase phase, or (ii) a TiO₂-bronze phase.

7. The TiO₂ nanostructure of claim 1, wherein prior to the charging and discharging process, the TiO₂ nanostructure is comprised of an amorphous phase.

8. The TiO₂ nanostructure of claim 1, wherein after the charging and discharging process, the TiO₂ nanostructure is comprised of a crystalline phase and an amorphous phase.

9. The TiO₂ nanostructure of claim 8, wherein after the charging and discharging process, the TiO₂ nanostructure is comprised of an inner crystalline phase and an outer amorphous phase, wherein the outer amorphous phase surrounds at least a portion of the inner crystalline phase.

10. The TiO₂ nanostructure of claim 9, wherein after the charging and discharging process, the inner crystalline phase comprises an anatase phase.

11. The TiO₂ nanostructure of claim 1, wherein the TiO₂ nanostructure comprises a nanotube, nanorod, nanowire, nanoflower, nanoflake, or nanoparticle.

12. A lithium-ion electrochemical cell comprising a first electrode and a second electrode separated by an electrolyte, wherein one of the first and second electrodes comprises the TiO₂ nanostructure of claim 1.

13. A lithium-ion battery comprising a plurality of electrochemically linked lithium-ion electrochemical cells, wherein each of the lithium-ion electrochemical cells comprises a first electrode and a second electrode separated by an electrolyte, wherein one of the first electrode and the second electrode comprises the TiO₂ nanostructure of claim 1.

14. A method for forming the TiO₂ nanostructure of claim 1, the method comprising:
mixing a TiO₂ nanostructure with a trace amount of conductive carbonaceous particles; and
calcining the mixture to obtain the TiO₂ nanostructure having a plurality of conductive carbonaceous particles attached thereto, wherein the weight composition of the conductive carbonaceous particles based on the total weight of the resultant TiO₂ nanostructure is 10.0 wt % or less.

15. The method of claim 14, wherein the calcination step is performed in a vacuum furnace.

16. The method of claim 14, wherein the calcination step is performed at a temperature of between 400 and 900° C.

17. The method of claim 16, wherein the calcination step is performed at 750° C.

18. The method of claim 14, wherein the calcination step is performed for a duration of between 20 min and 5 hours.

19. The method of claim 18, wherein the calcination step is performed for 2 hours.
